(19) United States
(12) Patent Application Publication
(10) Pub. No.: US 2014/0358649 A1
(43) Pub. Date: Dec. 4, 2014

(54) SYSTEM, METHODS, AND DEVICE FOR PROVIDING ADDITIONAL SERVICES WHEN CHARING ELECTRIC VEHICLE

(71) Applicant: SK PLANET CO., LTD., Seongnam-si, Gyeonggi-do (KR)

(72) Inventor: Dae Lim Son, Seoul (KR)

(21) Appl. No.: 14/374,432

(22) PCT Filed: Oct. 8, 2012
(86) PCT No.: PCT/KR2012/008130

§ 371 Date: Jul. 24, 2014

(30) Foreign Application Priority Data
Feb. 1, 2012 (KR) 10-2012-0010314

(51) Int. Cl. G06Q 30/02

(52) U.S. Cl. CPC G06Q 30/0241
USPC 705/14.4

(57) ABSTRACT

The present invention relates to a system, method, and device for providing additional services when charging an electric vehicle. The system, method, and device download and output content and advertising data through a secondary battery while charging a battery of the electric vehicle. A secondary battery charging device receives content and advertising data from a content providing device and an advertising providing device, respectively, while charging the battery of the electric vehicle, and transmits the received content and advertising data to a vehicle managing device. The vehicle managing device receives the content and advertising data from the secondary battery device, executes the content according to a user's input, and outputs the advertising data while executing the content. The vehicle managing device may transmit information regarding the number of outputs of the advertising data to the advertising providing device.

### TECHNICAL FIELD

The present invention relates to technology for providing additional services for an electric vehicle, and more particularly, a system, methods, and devices for providing additional services while an electric vehicle is being charged such that content and advertising data are downloaded through a secondary battery and are output while a battery of the electric vehicle is being charged.

### BACKGROUND ART

Today, vehicles have been continuously developed and improved, and have become a representative method for transportation. Recently, various types of cars such as large luxury cars and small economical cars have been introduced, and each household has held at least one vehicle.

In particular, recently, due to global environmental regulations and energy cost saving trends, demands for eco-friendly electric vehicles (EV) are increasing. The USA and Europe enact air conservation laws and propagation of the EV is becoming mandatory. In Korea, as part of low carbon green growth, interests and research on green cars (eco-friendly vehicle) have become active.

A battery of such an electric vehicle needs to be periodically charged for vehicle driving, and all electric functions of the electric vehicle stop while the battery is being charged. Therefore, improvement by which additional services can be received and executed even while the battery is being charged is necessary.

### DISCLOSURE

### Technical Problem

The invention provides a system, a method, and a device that can provide additional services by downloading content and advertising data even while a battery of an electric vehicle is being charged.

The invention also provides a system, a method, and a device that can output downloaded advertising data in random during executing content while a battery of an electric vehicle is being charged, and apply a discount rate to next battery recharging operations according to the number of outputting of advertising data.

### Technical Solution

One aspect of the present invention provides a system for providing additional services while an electric vehicle is being charged. This system includes a secondary battery device and a vehicle managing device. The secondary battery device is configured to, while a battery of the electric vehicle is being charged, respectively download content and advertising data from a content providing device and an advertisement providing device, and transmit the downloaded content and advertising data to the vehicle managing device. The vehicle managing device is configured to receive the content and advertising data from the secondary battery device, execute the content according to a user's input, and output the advertising data while the content is being executed.

In this system, the vehicle managing device may transmit information on the number of outputting of advertising data to the advertisement providing device.

The invention provides a secondary battery device. The secondary battery device includes a communication module and a control module. The communication module is configured to communicate with a content providing device and an advertisement providing device, receive content and advertising data, and transmit the received content and advertising data to a vehicle managing device while a battery of an electric vehicle is being charged. The control module is configured to control reception and transmission of the content and advertising data.

The secondary battery device may further include a storage module including a content DB configured to store the content received from the content providing device and an advertising data DB configured to store the advertising data received from the advertisement providing device.

The invention provides a vehicle managing device. The vehicle managing device includes a communication unit and a control unit. The communication unit is configured to communicate with a charging station managing device, transmit and receive data for battery charging of an electric vehicle, and receive content and advertising data from a secondary battery device. The control unit is configured to control reception of the content and advertising data, execute the content according to a user's input, and output the advertising data while the content is being executed.

The vehicle managing device may further include a storage unit including a content DB configured to store the content received from the secondary battery device and an advertising data DB configured to store the advertising data received from the advertisement providing device while the battery of the electric vehicle is being charged.

In the vehicle managing device, the communication unit may transmit information on the number of outputting of advertising data to the advertisement providing device under control of the control unit.

The invention provides an advertisement providing device. The advertisement providing device includes a communication module and a control module. The communication module is configured to transmit advertising data to a secondary battery device of an electric vehicle, and receive information on the number of outputting of advertising data, that is output from a vehicle managing device while a battery of the electric vehicle is being charged, from the vehicle managing device when the battery of the electric vehicle is recharged. The control module is configured to control transmission of the advertising data and reception of the information on the number of outputting of advertising data, calculate a discount rate of charging costs based on the information on the number of outputting of advertising data, and transmit the calculated discount rate information to a charging station managing device.

The invention provides a method of providing additional services while an electric vehicle is being charged, including requesting, by a secondary battery device, content download from a content providing device while a battery of the electric vehicle is being charged, downloading, by the secondary battery device, content from the content providing device, and advertising data from an advertisement providing device, and transmitting, by the secondary battery device, the downloaded content and advertising data to a vehicle managing device.

In this method, the transmitting, by the secondary battery device, of the content and advertising data to the vehicle managing device may be performed when battery charging is completed or downloading of the content and advertising data is completed.

The invention provides a method of providing additional services while an electric vehicle is being charged, including executing, by a vehicle managing device, battery charging of the electric vehicle, receiving, by the vehicle managing device, content and advertising data from a secondary battery device, executing, by the vehicle managing device, the content according to a user's input, and outputting, by the vehicle managing device, the advertising data while the content is being executed.

The method may further include storing, by the vehicle managing device, the number of outputting of advertising data.

The method may further include transmitting, by the vehicle managing device, the information on the number of outputting of advertising data to an advertisement providing device when battery recharging of the electric vehicle is executed, receiving, by the vehicle managing device, information on a discount rate of charging costs calculated by the advertisement providing device based on the information on the number of outputting of advertising data from the advertisement providing device, and paying, by the vehicle managing device, charging costs according to the received discount rate information.

The invention provides a method of providing additional services while an electric vehicle is being charged, including transmitting, by an advertisement providing device, advertising data to a secondary battery device of the electric vehicle, receiving, by the advertisement providing device, information on the number of outputting of advertising data from a vehicle managing device of the electric vehicle, calculating, by the advertisement providing device, a discount rate of charging costs based on the information on the number of outputting of advertising data, and transmitting, by the advertisement providing device, the calculated discount rate information to a charging station managing device.

### Advantageous Effects

According to the invention, while the battery of the electric vehicle is being charged, content and advertising data are downloaded through the secondary battery device so that it is possible to effectively use a battery charging time.

Moreover, while the downloaded content is being executed, advertising data is output in random so that it is possible to maximize advertising effects.

Further, when the battery of the electric vehicle is recharged, since a discount rate can be applied according to the number of outputting of previously downloaded advertising data, it is cost effective.

### DESCRIPTION OF DRAWINGS

FIG. 1 is a diagram illustrating a system for providing additional services while an electric vehicle is being charged according to an embodiment of the invention.

FIG. 2 is a block diagram illustrating a configuration of a vehicle managing device according to an embodiment of the invention.

FIG. 3 is a block diagram illustrating a configuration of a secondary battery device according to an embodiment of the invention.

FIG. 4 is a block diagram illustrating a configuration of a charging station managing device according to an embodiment of the invention.

FIG. 5 is a block diagram illustrating a configuration of an advertisement providing device according to an embodiment of the invention.

FIG. 6 is a diagram illustrating a data flow for providing additional services while an electric vehicle is charged according to an embodiment of the invention.

FIG. 7 is a diagram illustrating a data flow for battery recharging of an electric vehicle according to an embodiment of the invention.

FIG. 8 is a flowchart illustrating operations of the vehicle managing device according to the embodiment of the invention.

FIG. 9 is a flowchart illustrating operations of the secondary battery device according to the embodiment of the invention.

FIG. 10 is a flowchart illustrating operations of the advertisement providing device according to the embodiment of the invention.

### MODES OF THE INVENTION

Hereinafter, exemplary embodiments of the invention will be described in detail with reference to the accompanying drawings. However, detailed descriptions of well-known functions or configurations that unnecessarily obscure the gist of the invention in the following explanations and accompanying drawings will be omitted. The same reference numbers will be used throughout this specification to refer to the same or like parts.

Moreover, terms and words used in this specification and claims should not be interpreted as limited to commonly used meanings or meanings in dictionaries and should be interpreted with meanings and concepts which are consistent with the technological scope of the invention based on the principle that the inventors have appropriately defined concepts of terms in order to describe the invention in the best way. Therefore, since the embodiments described in this specification and configurations illustrated in drawings are only exemplary embodiments and do not represent the overall technological scope of the invention, it is understood that the invention covers various equivalents, modifications, and substitutions at the time of filing of this application.

Hereinafter, while a vehicle managing device according to an embodiment of the invention is described as a representative example of a mobile communication terminal that is connected to a communication network and can output content and advertising data, the terminal is not limited to the mobile communication terminal, but may be applied to various terminals, for example, all information communication devices, a multimedia terminal, a wired terminal, a fixed terminal, and an Internet Protocol (IP) terminal. Further, the terminal may be effectively used when the terminal is a mobile terminal having various mobile communication specifications, for example, a cellular phone, a portable multimedia player (PMP), a mobile Internet device (MID), a smartphone, a tablet PC, a laptop, a net book, a navigation, and an information communication device.

Meanwhile, “additional service” among terms used in this specification refers to executing or reproducing various pieces of content, and outputting advertising data while content is being executed or reproduced.

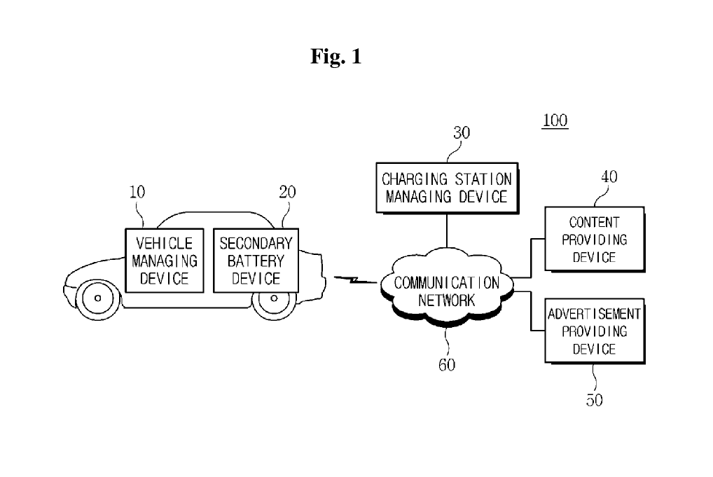

FIG. 1 is a diagram illustrating a system for providing additional services while an electric vehicle is being charged according to an embodiment of the invention.

As illustrated in FIG. 1, a system 100 for providing additional services while an electric vehicle is being charged according to the embodiment includes a vehicle managing device 10, a secondary battery device 20, a charging station managing device 30, a content providing device 40, an advertisement providing device 50, and a communication network 60.

The communication network 60 performs a series of data transmission and reception operations for data transmission and information exchange among the vehicle managing device 10, the secondary battery device 20, the charging station managing device 30, the content providing device 40, and the advertisement providing device 50.

When battery charging of the electric vehicle is completed, the vehicle managing device 10 receives a plurality of pieces of content and advertising data from the secondary battery device 20. Moreover, even when battery charging is not completed, the vehicle managing device 10 may receive content and advertising data from the secondary battery device 20. When content execution is requested, the vehicle managing device 10 reproduces content, and outputs advertising data while the content is being reproduced. Moreover, the vehicle managing device 10 stores the number of outputting of advertising data.

The secondary battery device 20 downloads a plurality of pieces of content and advertising data while a battery of the electric vehicle is being charged. In addition, the secondary battery device 20 transmits the downloaded content and advertising data to the vehicle managing device 10. Here, the secondary battery device 20 may transmit the downloaded content and advertising data to the vehicle managing device 10 regardless of battery charging completion of the electric vehicle. For example, after battery charging of the electric vehicle is completed, the secondary battery device 20 transmits the downloaded content and advertising data to the vehicle managing device 10. Moreover, even when downloading of content and advertising data is completed but battery charging of the electric vehicle is not completed, the secondary battery device 20 may transmit the downloaded content and advertising data to the vehicle managing device 10.

The charging station managing device 30 controls overall functions for battery charging of the electric vehicle. Particularly, the charging station managing device 30 receives discount rate information provided from the advertisement providing device 50, and requests payment for battery recharging of the electric vehicle based on the received discount rate.

The content providing device 40 transmits content to the secondary battery device 20 while the battery of the electric vehicle is being charged. Moreover, the content providing device 40 requests advertising data transmission from the advertisement providing device 50.

The advertisement providing device 50 provides a plurality of pieces of advertising data for the secondary battery device 20. When battery recharging of the electric vehicle is requested, the advertisement providing device 50 receives information on the number of outputting of advertising data from the vehicle managing device 10. Moreover, the advertisement providing device 50 calculates a discount rate of charging costs based on the information on the number of outputting of advertising data, and transmits the calculated discount rate information to the charging station managing device 30.

Moreover, when battery charging of the electric vehicle is completed in a state in which downloading of content and advertising data is not completed, the secondary battery device 20 according to the embodiment of the invention checks information on, for example, a remaining file capacity of content and advertising data and a data reception rate, and calculates a remaining time. In addition, the secondary battery device 20 transmits the calculated remaining time information to the vehicle managing device 10. Then, the vehicle managing device 10 provides the remaining time information for a vehicle driver through a screen output or an audio output.

In this way, content and advertising data are downloaded through the secondary battery device while the battery of the electric vehicle is being charged so that it is possible to effectively use a battery charging time. Moreover, while the downloaded content is being executed, advertising data is output in random so that it is possible to maximize advertising effects. Furthermore, when the battery of the electric vehicle is recharged, since a discount rate can be applied according to the number of outputting of previously downloaded advertising data, it is cost effective.

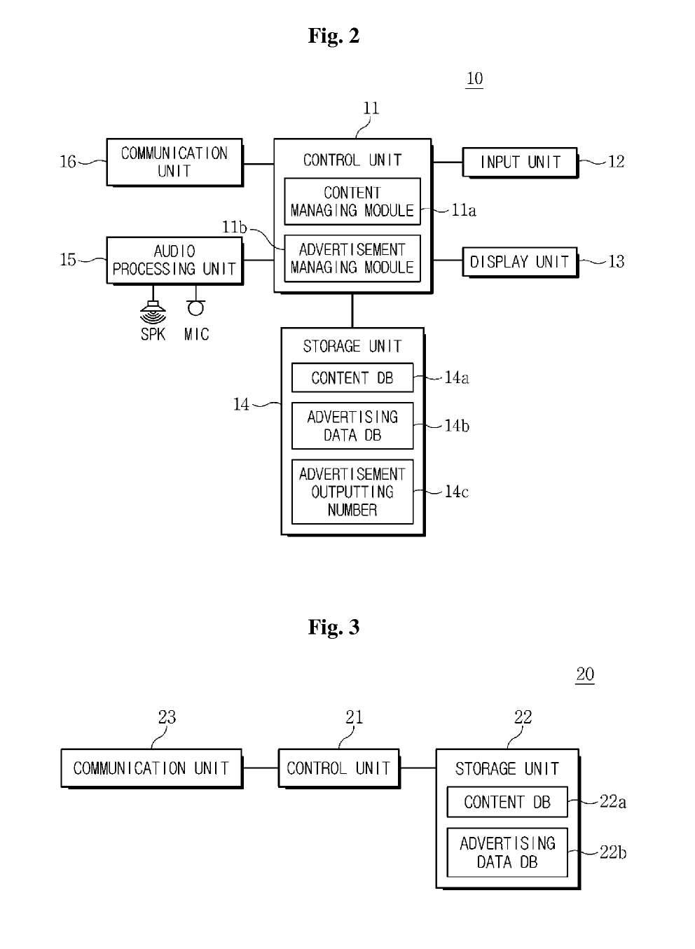

FIG. 2 is a block diagram illustrating a configuration of a vehicle managing device according to an embodiment of the invention.

As illustrated in FIG. 2, a vehicle managing device 10 according to the embodiment of the invention includes a control unit 11, an input unit 12, a display unit 13, a storage unit 14, an audio processing unit 15, and a communication unit 16. In this case, the control unit 11 includes a content managing module 11a and an advertisement managing module 11b. The storage unit 14 includes a content DB 14a, an advertising data DB 14b, and an advertisement outputting number 14c.

The input unit 12 receives various pieces of information, for example, number and text information, and delivers input signals related to setting of various functions and function control of a terminal 10 to the control unit 11. Moreover, the input unit 12 may include at least one of a keypad and a touchpad which generates input signals by a user's touch or manipulation. In this case, the input unit 12 may be configured as a single touch panel (or touch screen) type with the display unit 13 and simultaneously perform input and display functions. Moreover, the input unit 12 may include all types of input units will be developed in addition to input devices such as a keyboard, a keypad, a mouse, and a joystick.

The display unit 13 displays information on, for example, a series of operations states and operation results generated while functions of the terminal 10 are performed. Moreover, the display unit 13 may display, for example, menus of the terminal 10, and user data input by the user. Here, the display unit 13 may include, for example, a liquid crystal display (LCD), a thin film transistor LCD (TET-LCD), an organic light emitting diode (OLED), a light-emitting diode (LED), an active matrix organic LED (AMOLED), a flexible display, and a 3-dimensional (3D) display. In this case, the display unit 13 may be configured with a touch screen type. When the display unit 13 is configured with such as touch screen type, the display unit 13 may perform some or all functions of the input unit 12.

Particularly, the display unit 13 according to the embodiment of the invention outputs downloaded content and advertising data while the battery of the electric vehicle is being charged.

The storage unit 14 is configured to store data, includes a main memory device and a secondary memory device, and stores applications necessary for function operations of the terminal 10. This storage unit 14 may include a program area and a data area. Here, when each function is activated according to a user's request, the terminal 10 executes corresponding applications under control of the control unit 11 and provides each function. In particular, the program area according to the embodiment of the invention stores, for example, an operating system for booting the terminal 10, the content managing module 11a, and the advertisement managing module 11b. Moreover, the data area stores data generated when the terminal 10 is used. Specifically, the data area according to the embodiment of the invention stores, for example, the content DB 14a, the advertising data DB 14b, and the advertisement outputting number 14c. Here, the content DB 14a includes the plurality of pieces of content downloaded to the secondary battery device 20 while the battery of the electric vehicle is being charged, the advertising data DB 14b includes the plurality of pieces of advertising data received from the advertisement providing device 50, and the advertisement outputting number 14c refers to the number of outputting of advertising data.

The audio processing unit 15 reproduces and outputs audio signals to a speaker (SPK) or delivers audio signals input from a microphone (MIC) to the control unit 11. This audio processing unit 15 may convert audio signals having an analog type input from the microphone to audio signals having a digital type, and deliver the converted signal to the control unit 11. Moreover, the audio processing unit 15 may convert audio signals having a digital type output from the control unit 11 to analog signals, and output the converted signal to the speaker. In particular, the audio processing unit 15 outputs all effect sounds, setting sounds, or execution sounds for function execution of the terminal 10 and content and advertising data.

The communication unit 16 transmits and receives data with a service device 30 via a communication network 40. Here, the communication unit 16 includes, for example, an RF transmitting unit configured to up-convert and amplify a frequency of transmitting signals, and an RF receiving unit configured to low-noise amplify receiving signals and down-convert a frequency. This communication unit 16 may include at least one of a wireless communication module (not illustrated) and a wired communication module (not illustrated). Further, the wireless communication module is configured to transmit and receive data based on a wireless communication method. When the terminal 10 uses wireless communication, it is possible to transmit or receive data to or from the service device 30 using any one of a wireless network communication module, a wireless LAN communication module, and a wireless PAN communication module. The wired communication module is configured to transmit and receive data using a wired line. The wired communication module may access the communication network 40 using a wired line, and transmit or receive data to or from the service device 30. That is, the terminal 10 may access the communication network 40 using the wired communication module, and transmit or receive data to or from the service device 30 via the communication network 40. In particular, the communication unit 16 according to the embodiment of the invention receives downloaded content and advertising data from the secondary battery device 20 while the battery of the electric vehicle is being charged.

The control unit 11 may be an operation system (OS) or a processing unit configured to drive each component. The control unit 11 may be, for example, a central processing unit (CPU). In particular, the control unit 11 according to the embodiment of the invention receives a plurality of pieces of content and advertising data from the secondary battery device 20 when battery charging of the electric vehicle is completed. When content execution is requested, the control unit 11 outputs advertising data while the content is being reproduced and stores the number of outputting of advertising data. Here, the control unit 11 includes a content managing module 11a configured to execute content according to the user's input, and an advertisement managing module 11b configured to output advertising data in random while the content is being executed.

FIG. 3 is a block diagram illustrating a configuration of a secondary battery device according to an embodiment of the invention.

As illustrated in FIG. 3, a secondary battery device 20 according to the invention includes a control unit 21, a storage unit 22, and a communication unit 23. In this case, the storage unit 22 includes a content DB 22a and an advertising data DB 22b.

While the battery of the electric vehicle is being charged, the communication unit 23 communicates with the content providing device 40 and the advertisement providing device 50 and receives a plurality of pieces of content and advertising data. Moreover, the communication unit 23 transmits the content and advertising data to the vehicle managing device 10 when battery charging is completed.

The storage unit 22 stores data for executing functions of the secondary battery device 20. In particular, the storage unit 22 includes a content DB 22a configured to store content received from the content providing device 40 and an advertising data DB 22b configured to store the advertising data received from the advertisement providing device 50.

The control unit 21 controls overall functions of the secondary battery device 20. In particular, the control unit 21 downloads a plurality of pieces of content and advertising data while the battery of the electric vehicle is being charged. Moreover, the control unit 21 transmits the downloaded content and advertising data to the vehicle managing device 10 of the electric vehicle. Here, the control unit 21 may transmit the downloaded content and advertising data to the vehicle managing device 10 of the electric vehicle regardless of battery charging completion of the electric vehicle. For example, after battery charging of the electric vehicle is completed, the control unit 21 transmits the downloaded content and advertising data to the vehicle managing device 10. Moreover, even when downloading of content and advertising data is completed but battery charging of the electric vehicle is not completed, the control unit 21 may transmit the downloaded content and advertising data to the vehicle managing device 10.

Moreover, when battery charging of the electric vehicle is completed in a state in which downloading of content and advertising data is not completed, the secondary battery device 20 according to the embodiment of the invention checks information on, for example, a remaining file capacity of content and advertising data and a data reception rate, and calculates a remaining time. In addition, the secondary battery device 20 transmits the calculated remaining time information to the vehicle managing device 10.

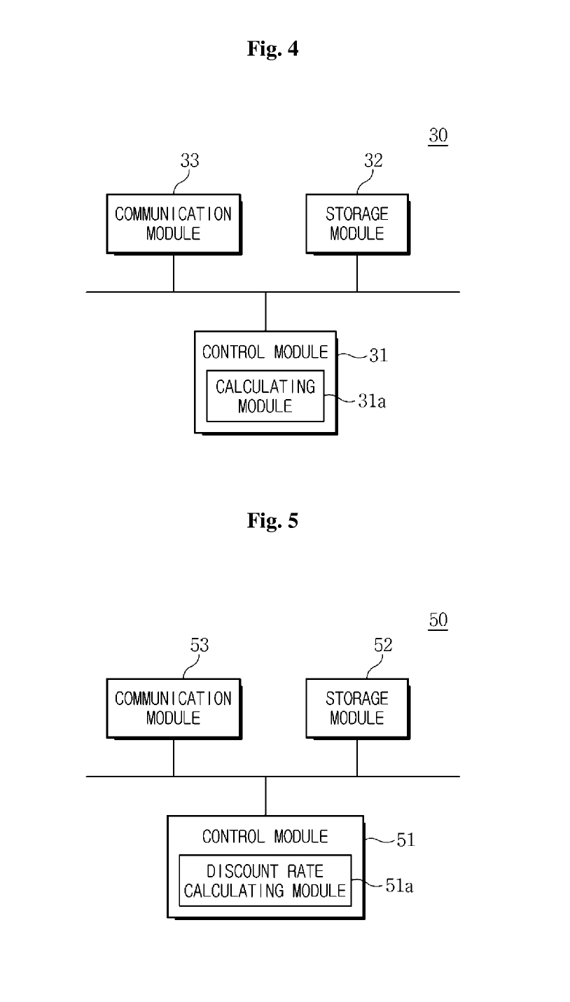

FIG. 4 is a block diagram illustrating a configuration of a charging station managing device according to an embodiment of the invention.

As illustrated in FIG. 4, a charging station managing device 30 according to the invention includes a control module 31, a storage module 32, and a communication module 33. In this case, the control module 31 includes a calculating module 31a.

The communication module 33 communicates with the vehicle managing device 10, and transmits and receives data on battery charging of the electric vehicle.

The storage module 32 stores overall data according to function execution of the charging station managing device 30.

The control module 31 controls functions for battery charging of the electric vehicle according to a request from the vehicle managing device 10. Moreover, the control module 31 requests payments for battery charging from the vehicle managing device 10 according to discount rate information received from the advertisement providing device 50.

FIG. 5 is a block diagram illustrating a configuration of an advertisement providing device according to an embodiment of the invention.

As illustrated in FIG. 5, an advertisement providing device 50 according to the invention includes a control module 51, a storage module 52, and a communication module 53. In this case, the control module 51 includes a discount rate calculating module 51a.

The communication module 53 transmits a plurality of pieces of advertising data to the secondary battery device 20 of the electric vehicle. Moreover, when the battery of the electric vehicle is recharged, the communication module 53 receives information on the number of outputting of advertising data from the vehicle managing device 10.

The storage module 52 stores data for executing functions of the advertisement providing device 50.

The control module 51 controls overall functions of the advertisement providing device 50. In particular, the control module 51 transmits a plurality of pieces of advertising data to the secondary battery device 20. When battery recharging of the electric vehicle is requested, the control module 51 receives information on the number of outputting of advertising data and calculates a discount rate of charging costs based on the information on the number of outputting of advertising data. Then, the control module 51 transmits the calculated discount rate information to the charging station managing device 30.

Moreover, the content providing device 40 and the advertisement providing device 50 configured as described above may be implemented by at least one server operated as a server-based computing method or a cloud method. In particular, the content and advertising data may be provided by a cloud computing function that can be permanently stored in a cloud computing device over the Internet. Here, cloud computing refers to technology for providing virtualized information technology (IT) resources such as hardware (for example, a server, a storage, or a network), software (for example, a database, security, or a web server), services, or data on demand utilizing Internet technology in a digital terminal such as a desktop, a tablet computer, a laptop computer, a netbook or a smart phone. In the invention, the content and advertising data may be stored in the cloud computing device over the Internet and used in any time and any place through the vehicle managing device 10.

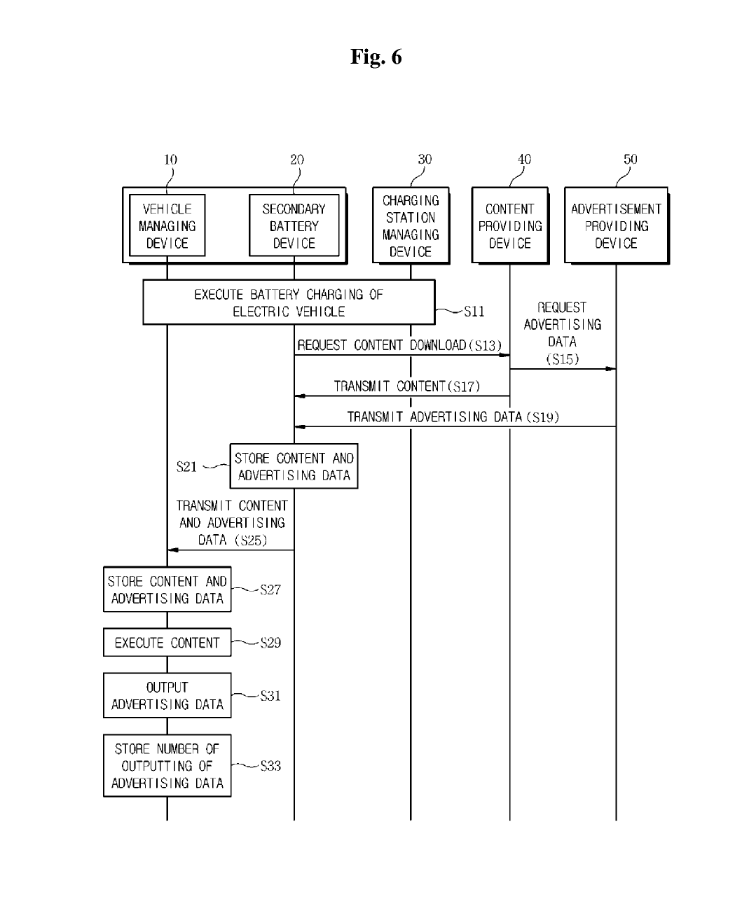

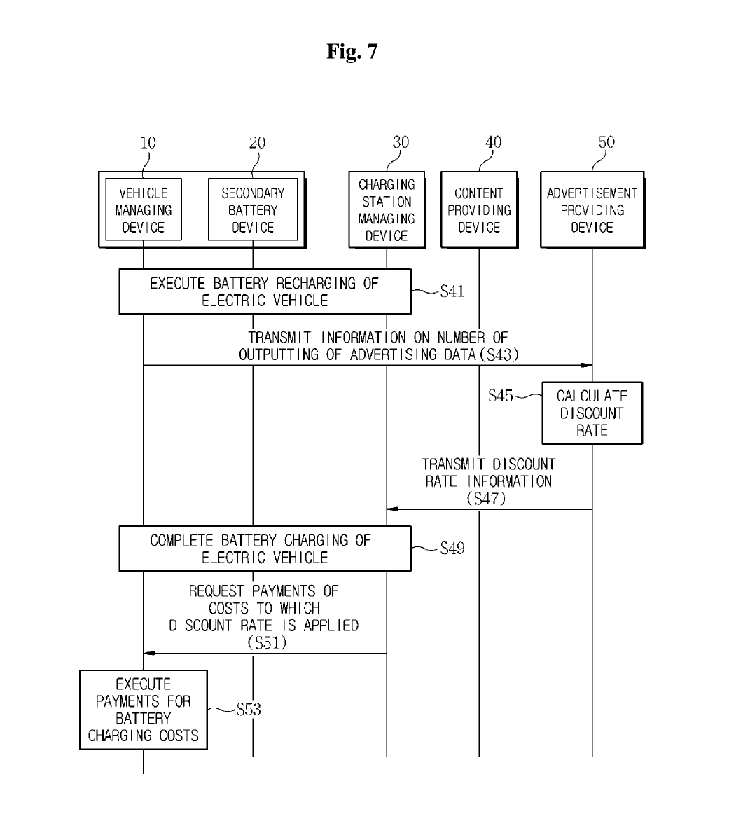

FIG. 6 is a diagram illustrating a data flow for providing additional services while an electric vehicle is charged according to an embodiment of the invention.

As illustrated in FIG. 6, in operation S11, the vehicle managing device 10 and the charging station managing device 30 of the electric vehicle according to the invention execute battery charging of the electric vehicle.

In operation S13, the secondary battery device 20 requests content download from the content providing device 40. Then, in operation S15, the content providing device 40 requests advertising data from the advertisement providing device 50 according to a request from the secondary battery device 20. Then, in operation S17, the content providing device 40 transmits a plurality of pieces of content to the secondary battery device 20. Moreover, in operation S19, the advertisement providing device 50 transmits a plurality of pieces of advertising data to the secondary battery device 20.

In operation S21, the secondary battery device 20 stores downloaded content and advertising data.

In operation S25, the secondary battery device 20 transmits the stored content and advertising data to the vehicle managing device 10 of the electric vehicle. Here, the secondary battery device 20 may transmit the downloaded content and advertising data to the vehicle managing device 10 regardless of battery charging completion of the electric vehicle. For example, after battery charging of the electric vehicle is completed, the secondary battery device 20 transmits the downloaded content and advertising data to the vehicle managing device 10. Moreover, even when downloading of content and advertising data is completed but battery charging of the electric vehicle is not completed, the secondary battery device 20 may transmit the downloaded content and advertising data to the vehicle managing device 10. Then, in operation S27, the vehicle managing device 10 stores content and advertising data.

When content execution is requested while the vehicle is driving, in operation S29, the vehicle managing device 10 executes the downloaded content. While the content is being executed, in operation S31, the vehicle managing device 10 outputs advertising data in random. Then, in operation S33, the vehicle managing device 10 stores the number of outputting of advertising data.

Moreover, when battery charging of the electric vehicle is completed in a state in which downloading of content and advertising data is not completed, the secondary battery device 20 according to the embodiment of the invention checks information on, for example, a remaining file capacity of content and advertising data and a data reception rate, and calculates a remaining time. In addition, the secondary battery device 20 transmits the calculated remaining time information to the vehicle managing device 10. Then, the vehicle managing device 10 provides the remaining time information to a vehicle driver through a screen output or an audio output.

In this way, content and advertising data are downloaded through the secondary battery device while the battery of the electric vehicle is being charged so that it is possible to effectively use a battery charging time. Moreover, while the downloaded content is being executed, advertising data is output in random so that it is possible to maximize advertising effects. Furthermore, when the battery of the electric vehicle is recharged, since a discount rate can be applied according to the number of outputting of previously downloaded advertising data, it is cost effective.

FIG. 7 is a diagram illustrating a data flow for battery recharging of an electric vehicle according to an embodiment of the invention.

As illustrated in FIG. 7, in operation S41, the vehicle managing device 10 and the charging station managing device 30 of the electric vehicle according to the invention executes battery recharging of the electric vehicle.

When battery recharging is executed, in operation S43, the vehicle managing device 10 transmits information on the number of outputting of advertising data that is output in random while the content is being executed to the advertisement providing device 50.

When the information on the number of outputting of advertising data is received, in operation S45, the advertisement providing device 50 calculates a discount rate. That is, the advertisement providing device 50 calculates a discount rate that can be applied to battery charging costs of the electric vehicle. Then, in operation S47, the advertisement providing device 50 transmits the calculated discount rate information to the charging station managing device 30.

In operation S49, the vehicle managing device 10 and the charging station managing device 30 complete battery charging of the electric vehicle. Then, in operation S51, the charging station managing device 30 requests payments of costs to which the discount rate is applied from the vehicle managing device 10.

In operation S53, the vehicle managing device 10 executes payments for battery charging costs.

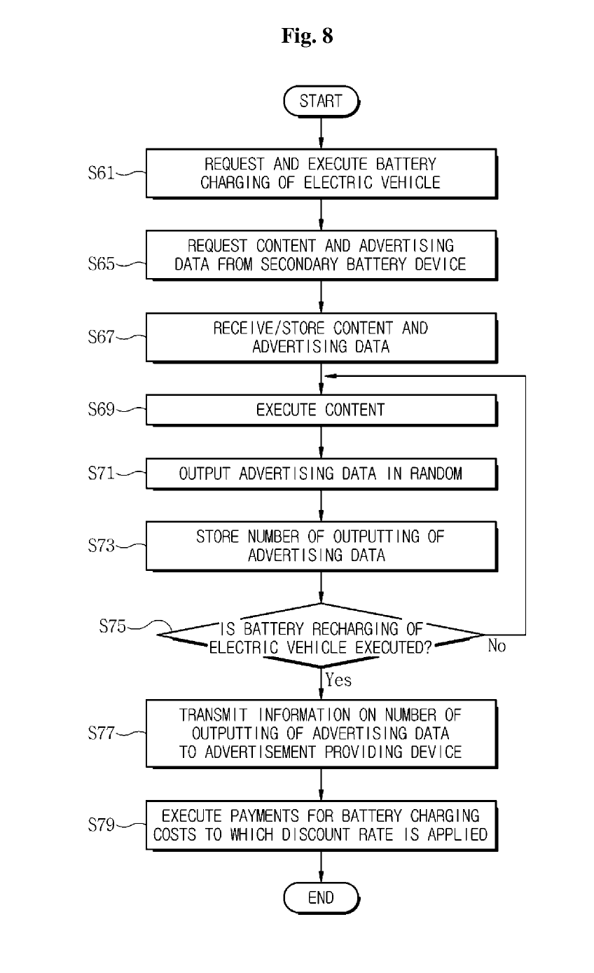

FIG. 8 is a flowchart illustrating operations of the vehicle managing device according to the embodiment of the invention.

As illustrated in FIG. 8, in operation S61, the vehicle managing device 10 according to the invention requests battery charging of the electric vehicle from the charging station managing device 30, and executes battery charging.

In operation S65, the vehicle managing device 10 requests content and advertising data from the secondary battery device 20. In this case, the vehicle managing device 10 may receive downloaded content and advertising data through the secondary battery device 20 after battery charging is completed, or receive downloaded content and advertising data through the secondary battery device 20 even when battery charging is not completed.

Then, in operation S65, the vehicle managing device 10 receives content and advertising data from the secondary battery device 20 and stores the received content and advertising data.

When content execution is requested while the vehicle is driving, in operation S69, the vehicle managing device 10 executes the downloaded content. While the content is being executed, in operation S71, the vehicle managing device 10 outputs advertising data in random. Then, in operation S73, the vehicle managing device 10 stores the number of outputting of advertising data.

In operation S75, the vehicle managing device 10 determines whether battery recharging of the electric vehicle is executed. When battery recharging is executed, in operation S77, the vehicle managing device 10 transmits information on the number of outputting of advertising data that is output in random while the content is being executed to the advertisement providing device 50.

In operation S79, the charging station managing device 30 executes payments for battery charging costs according to a request for payments of costs to which the discount rate is applied from the vehicle managing device 10.

In this way, content and advertising data are downloaded through the secondary battery device while the battery of the electric vehicle is being charged so that it is possible to effectively use a battery charging time. Moreover, while the downloaded content is being executed, advertising data is output in random so that it is possible to maximize advertising effects. Furthermore, when the battery of the electric vehicle is recharged, since a discount rate can be applied according to the number of outputting of previously downloaded advertising data, it is cost effective.

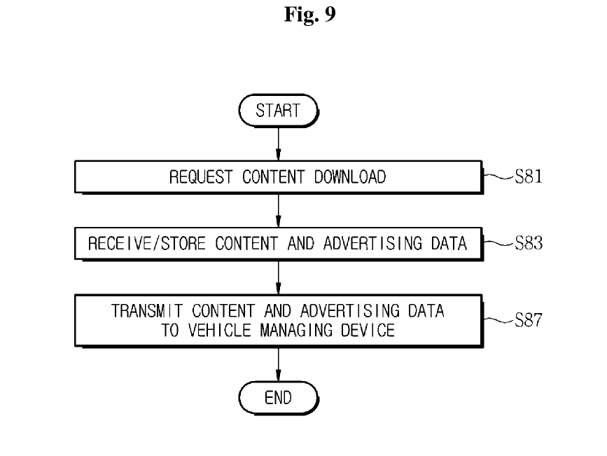

FIG. 9 is a flowchart illustrating operations of the secondary battery device according to the embodiment of the invention.

As illustrated in FIG. 9, in operation S81, when battery charging of the electric vehicle is executed, the secondary battery device 20 according to the invention requests content download from the content providing device 40. Then, in operation S83, the secondary battery device 20 receives a plurality of pieces of content and advertising data from the content providing device 40 and the advertisement providing device 50, and stores the content and advertising data.

In operation S87, the secondary battery device 20 transmits stored content and advertising data to the vehicle managing device 10 of the electric vehicle. Here, the secondary battery device 20 may transmit the downloaded content and advertising data to the vehicle managing device 10 regardless of battery charging completion of the electric vehicle. For example, after battery charging of the electric vehicle is completed, the secondary battery device 20 transmits the downloaded content and advertising data to the vehicle managing device 10. Moreover, even when downloading of content and advertising data is completed but battery charging of the electric vehicle is not completed, the secondary battery device 20 may transmit the downloaded content and advertising data to the vehicle managing device 10.

Moreover, when battery charging of the electric vehicle is completed in a state in which downloading of content and advertising data is not completed, the secondary battery device 20 according to the embodiment of the invention checks information on, for example, a remaining file capacity of content and advertising data and a data reception rate, and calculates a remaining time. In addition, the secondary battery device 20 transmits the calculated remaining time information to the vehicle managing device 10.

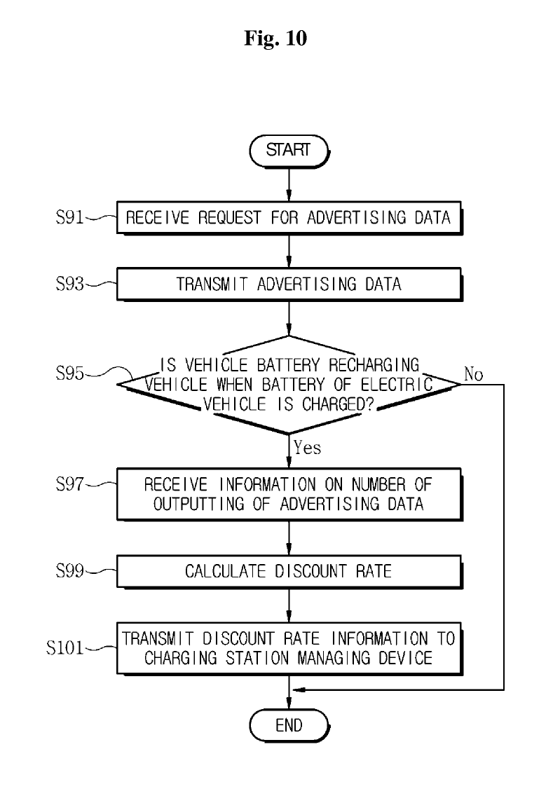

FIG. 10 is a flowchart illustrating operations of the advertisement providing device according to the embodiment of the invention.

As illustrated in FIG. 10, in operation S91, the advertisement providing device 50 according to the invention receives a request for advertising data from the content providing device 40. Then, in operation S93, the advertisement providing device 50 transmits a plurality of pieces of advertising data to the secondary battery device 20.

In operation S95, when battery charging of the electric vehicle is requested, the advertisement providing device 50 checks whether the vehicle is a battery recharging vehicle. When it is checked as the battery recharging vehicle, in operation S97, the advertisement providing device 50 receives information on the number of outputting of advertising data from the vehicle managing device 10.

When the information on the number of outputting of advertising data is received, in operation S101, the advertisement providing device 50 calculates a discount rate, and transmits the calculated discount rate information to the charging station managing device 30.

The method of providing content and advertisement of the electric vehicle according to the invention may be implemented in a type of software that can be read by various computer means and may be recorded in a computer-readable recording medium. Here, the recording medium may include any one of or a combination of, for example, program instructions, data files, and data structures. The program instructions recorded in the recording medium may be specially designed and configured for the invention or may also be known and available for those skilled in computer software. Examples of the recording medium include a hard disk, a floppy disk, magnetic media such as a magnetic tape, optical media such as a compact disk read only memory (CD-ROM) and a digital video disk (DVD), magneto-optical media such as a floptical disk, and a specifically designed hardware device for storing and performing program instructions such as a ROM, random access memory (RAM), and flash memory. Examples of the program instructions may include a machine code generated by a compiler and a high-level code can be executed by a computer using, for example, an interpreter. Such a hardware device may be configured to be operated as at least one software module to perform operations of the invention and vice versa.

Meanwhile, the embodiments of the invention disclosed in this specification and drawings are only examples to facilitate understanding, and the invention is not limited thereto. It is apparent to those skilled in the art that various modifications based on the technological scope of the invention in addition to the embodiments disclosed herein can be made.

According to the invention, while the battery of the electric vehicle is being charged, content and advertising data are downloaded through the secondary battery and are output. In this way, content and advertising data are downloaded through the secondary battery device while the battery of the electric vehicle is being charged so that it is possible to effectively use a battery charging time. Moreover, while the downloaded content is being executed, advertising data is output in random so that it is possible to maximize advertising effects. Furthermore, when the battery of the electric vehicle is recharged, since a discount rate can be applied according to the number of outputting of previously downloaded advertising data, it is cost effective. This is highly likely to be commercialized or be sold, and can be clearly implemented in reality so that the invention has industrial applicability.

1-2. (canceled)

3. A secondary battery device comprising:
a communication module configured to communicate with a content providing device and an advertisement providing device, receive content and advertising data, and transmit the received content and advertising data to a vehicle managing device while a battery of an electric vehicle is being charged; and
a control module configured to control reception and transmission of the content and advertising data.

4. The secondary battery device of claim 3, further comprising a storage module including a content DB configured to store the content received from the content providing device and an advertising data DB configured to store the advertising data received from the advertisement providing device.

5. A vehicle managing device comprising:
a communication unit configured to communicate with a charging station managing device, transmit and receive data for battery charging of an electric vehicle, and receive content and advertising data from a secondary battery device; and
a control unit configured to control reception of the content and advertising data, execute the content according to a user's input, and output the advertising data while the content is being executed.

6. The vehicle managing device of claim 5, further comprising a storage unit including a content DB configured to store the content received from the secondary battery device and an advertising data DB configured to store the advertising data received from the advertisement providing device while the battery of the electric vehicle is being charged.

7. The vehicle managing device of claim 5, wherein the communication unit transmits information on the number of outputting of advertising data to the advertisement providing device under control of the control unit.

8. (canceled)

9. A method of providing additional services while an electric vehicle is being charged, comprising:
requesting, by a secondary battery device, content download from a content providing device while a battery of the electric vehicle is being charged;
downloading, by the secondary battery device, content from the content providing device, and advertising data from an advertisement providing device; and
transmitting, by the secondary battery device, the downloaded content and advertising data to a vehicle managing device.

10. The method of claim 9, wherein the transmitting, by the secondary battery device, of the downloaded content and advertising data to the vehicle managing device is performed when battery charging is completed or downloading of the content and advertising data is completed.

11-14. (canceled)
